(19) United States
(12) Patent Application Publication
(10) Pub. No.: US 2006/0033747 A1
(43) Pub. Date: Feb. 16, 2006

(54) DIGITAL TV IMAGE PROCESSING CIRCUIT

(76) Inventors: Zou-Ping Chen, Tai-Chung City (TW); Tsung-Chi Lin, Taipei City (TW); Te-Ming Kuo, Hsin-Chu Hsien (TW); Cheng-Shun Liao, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,719

(22) Filed: Aug. 15, 2005

(30) Foreign Application Priority Data
Aug. 16, 2004 (TW) 093124577

(51) Int. Cl. G09G 5/02

(52) U.S. Cl. 345/592

(57) ABSTRACT

An image processing circuit of a digital TV includes a graphic drawing module. The graphic drawing module is capable of selecting a first blending value or a second blending value to process a pixel to generate target image data and store the target image data in a memory. While performing a gradient operation that generates a plurality of pixel values, the graphic drawing module determines whether or not to limit the pixel values to a specific interval according to a saturation parameter.

### BACKGROUND OF THE INVENTION

1. Field of the Invention

The present invention relates to a digital TV, and more particularly, to an image processing circuit for a digital TV.

2. Description of the Prior Art

Compared with conventional CRTs, LCD panels and PDP panels have the property of low thickness-to-display-size ratio, and thereby possess considerable predominance on high-level TVs of large displaying size. As the technology of LCD and PDP panels advances, high-level TVs equipped with LCD or PDP panels are becoming more and more popular. Because of the large screen size, the modern high-level TV generally supports a picture-in-picture (PIP) function. Therefore, a user can watch two TV programs on the one TV screen at the same time.

However, some users are not satisfied with the PIP function of a digital TV which simply displays two pictures on the same large-sized screen. They expect more variations on the functionality of the digital TV. For example, the digital TV should be capable of performing specific image processing operations upon the displayed pictures for some special visual effects. However, the prior art digital TV is deficient in such kind of image processing abilities.

### SUMMARY OF THE INVENTION

It is therefore one of the objectives of the claimed invention to provide an image processing circuit for a digital TV, to solve the above-mentioned problem.

The claimed invention provides an image processing circuit comprising: a memory for storing source image data having a first format, the source image data comprising a first blending value and first data; a storage unit for storing a blending selection value; and a graphic drawing module for producing a second blending value according to the first data, selecting the first blending value or the second blending value according to the blending selection value, and converting the source image data into target image data according to the selected blending value and the first data.

The claimed invention further provides an apparatus for processing source image data. The apparatus comprises: a storage unit for storing at least one gradient parameter; a graphic drawing module for receiving the source image data to perform a gradient operation and outputting the target image data having a gradient effect, wherein the gradient parameter corresponds to the gradient effect; and a memory coupled to the graphic drawing module for storing the target image data.

The claimed invention further provides an method for processing source image data, the method comprising: receiving the source image data from a memory, the source image data comprising a first blending value and first data; receiving a blending selection value from a storage unit; producing a second blending value according to the first data; selecting the first blending value or the second blending value according to the blending selection value; and converting the source image data into target image data according to the selected blending value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a digital TV according to the present invention.

FIG. 2 is a diagram of an image processing circuit according to the present invention.

FIG. 3 is a diagram of a command format received by the graphic drawing module shown in FIG. 1.

FIG. 4 is a diagram illustrating image format conversions performed by the graphic drawing module shown in FIG. 1.

FIG. 5 is a reference table of different format conversions performed by the graphic drawing module shown in FIG. 1.

FIG. 6 is a diagram of format conversion rules used by the graphic drawing module in response to the format conversions shown in FIG. 5.

### DETAILED DESCRIPTION

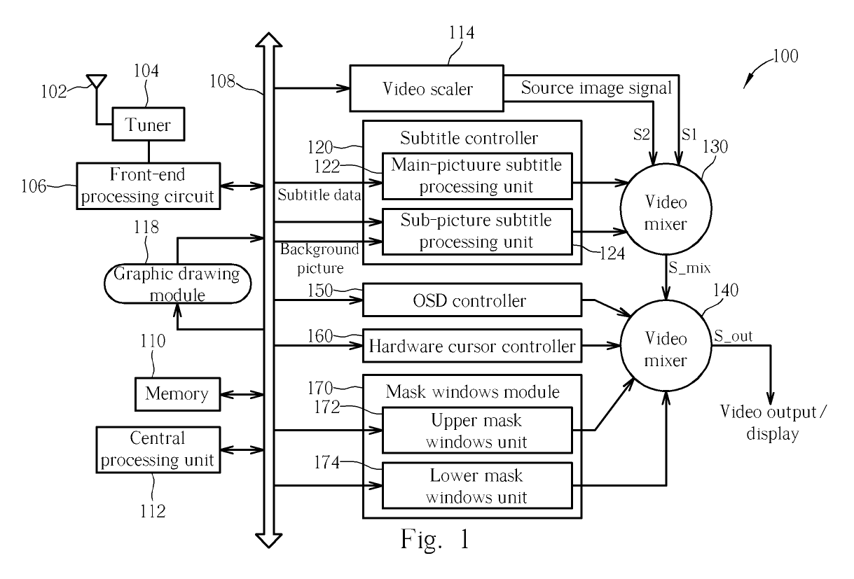

FIG. 1 is a block diagram illustrating the system architecture of a digital TV 100 according to the present invention. As shown in FIG. 1, the digital TV 100 comprises an antenna 102, a tuner 104, a front-end processing circuit 106, a bus 108, a memory 110, a central processing unit (CPU) 112, a video scaler 114, a graphic drawing module (GDM) 118, a subtitle controller 120, a plurality of video mixers 130 and 140, an on-screen display (OSD) controller 150, a hardware cursor controller 160, and a mask windows module 170. The front-end processing circuit 106, after performing front-end processing on the digital TV signal received from the antenna 102 and the tuner 104, stores the processed data into the memory 110 through the bus 108. The CPU 112 can control other devices connected to the bus 108.

The video scaler 114 reads image data corresponding to a main-picture and a sub-picture from the memory 110, and generates a main-video signal S1 and a sub-video signal S2 by scaling the image size of the read image data. After being processed by video mixers 130, 140, the video signal S1, S2 and other information are mixed to successively generate a corresponding mixed signal S_mix and an output signal S_out of a composed picture. The output signal S_out is further transmitted to a monitor, a video output port, or a video output end of the digital TV 100. Users can watch the composed pictures through the monitor of digital TV 100 or a monitor of an external display unit coupled to the video output port or the video output end of the digital TV 100.

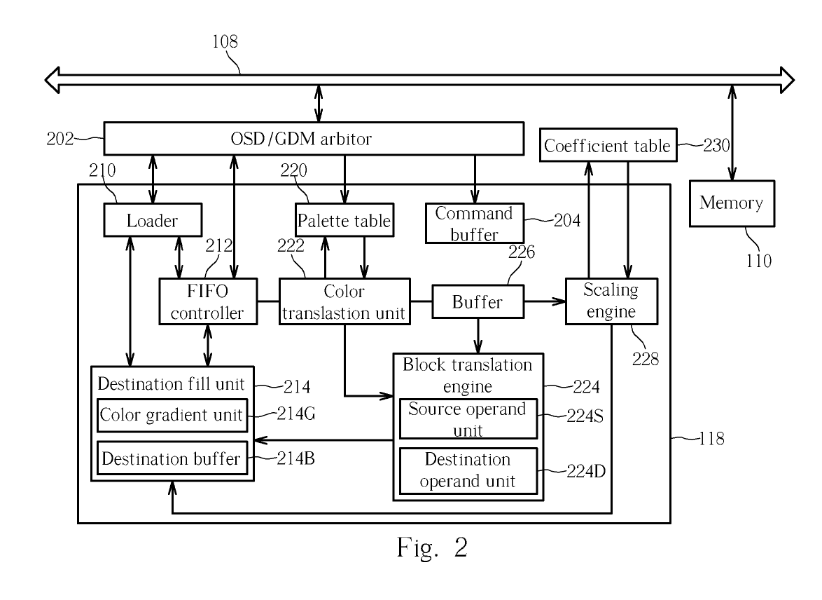

As shown in FIG. 2, the above-mentioned bus 108, memory 1110, and GDM 118 constitute an image processing circuit which provides the digital TV 100 with the image processing functionality. The GDM 118 comprises a command buffer 204, a loader 210, a first-in-fist-out (FIFO) controller 212, a destination fill unit 214, a palette table 220, a color translation unit 222, a block translation engine (BLT engine) 224, a buffer 226, and a scaling engine 228. Additionally, the destination fill unit 214 comprises a color gradient unit 214G and a destination buffer 214B, and the BLT engine 224 comprises a source operand unit 224S and a destination operand unit 224D. Please note that the above-mentioned devices, the OSD/GDM arbitor 202, and the coefficient table 230 could be positioned inside or outside the GDM 118, which are design choices and are not meant to be limitations.

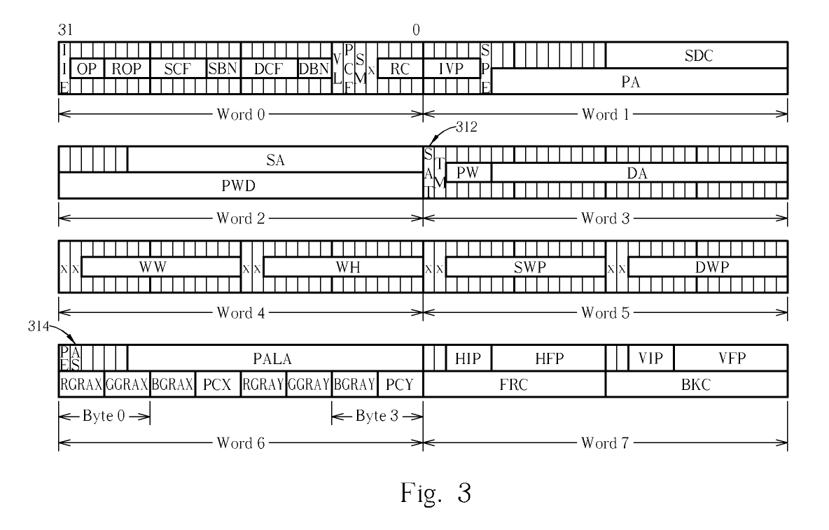

In an embodiment, the GDM 118 can operate off-line and is not limited to performing the real-time image processing when the digital TV 100 is playing a TV program. Through the bus 108, the GDM 118 can read the image data from the memory 110 for image processing, write the processed image data into the memory 110, and even write image data generated by itself into the memory 110. Therefore, the GDM 118 can cooperate with other devices at will. The GDM 118 can work according to commands issued from the CPU 112 shown in FIG. 1, and the bit information of each command is stored in the command buffer 204. The command format is illustrated in FIG. 3 and comprises some shared bit information, which may not be processed simultaneously. For example, in the last word, the function corresponding to bit information VIP and VFP will not be performed in conjunction with the function corresponding to the bit information BKC. Through the use of the shared bit information VIP, VFP and BKC, the present invention can realize a command format having a shorter length.

When performing a gradient operation, the GDM 118 uses the color gradient unit 214G to run the gradient operation according to the bit information RGRAX, GGRAX, BGRAX, PCX, RGRAY, GGRAY, BGRAY and PCY, as shown in the bottom left of FIG. 3. The bit information PCX, PCY defines the pixel number of each gradient step along X and Y axes in an image while remaining bit information RGRAX, GGRAX and BGRAX defines the gray level variations of red color (R), green color (G) and blue color (B) corresponding to each gradient step along the X axis. For example, if (RGRAX, GGRAX, BGRAX, PCX) is equal to (1,1,2,5), the GDM 118 will change the gray level every 5 pixels when performing the gradient operation along the X axis and the gray level variations corresponding to red color, green color and blue color are 1 gray level, 1 gray level and 2 gray levels for their respective gradient steps. The bit information RGRAY, GGRAY, BGRAY and PCY corresponds to the parameters for the gradient operation performed along the Y axis, and further description is omitted here for brevity. Due to the fact that there is no need for a division operation, the present invention can achieve the objective of having simple operation. As for the saturation bit (SAT bit) 312, it is used for controlling the above-mentioned gradient operation. When the SAT bit 312 is enabled, if a pixel value ascends (or descends) to reach the maximum (or minimum) of a saturation color during the gradient operation, the following pixel values are set by this maximum (or minimum) of the saturation color. Conversely, when the SAT bit 312 is disabled, the GDM 118 will not stay at the maximum or minimum of the saturation color when performing the gradient operation.

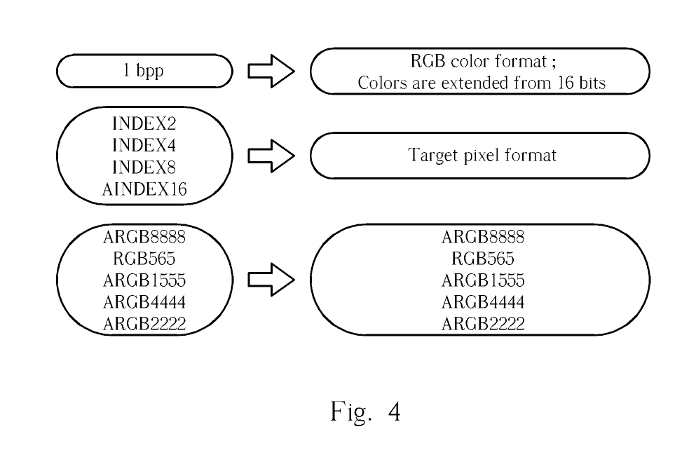

In this embodiment, when an image conversion is activated, the blending selection value AS shown in FIG. 3 is a blending selection bit 314 used for alpha selection, i.e., used for controlling the image format conversion run in the GDM 118. In this embodiment, the GDM 118 can receive a plurality of image formats and then convert them into other formats, respectively. FIG. 4 is a diagram illustrating possible image format conversions performed by the GDM 118 according to the present invention.

A 16-bit alpha color look-up table (ACLUT16) format of image data comprises 8-bit blending value (first alpha) and 8-bit color look-up table (CLUT) value. Another blending value (second alpha) and RGB data stored in the palette table 220 will be found according to the 8-bit CLUT value. That is, the 8-bit CLUT value is an index for looking up an alpha-RGB value from the palette table 220. The alpha-RGB value comprises the second alpha and RGB data. For example, if the GDM 118 is activated to convert image data of an ACLUT16 format into image data of an RGB format, the GDM 118 converts the 8-bit CLUT value into an alpha-RGB value (that is, the alpha of the alpha-RGB value is a second blending value). The GDM 118 will select one of the first blending value or the second blending value to blending the RGB data and the background according to the selected blending value.

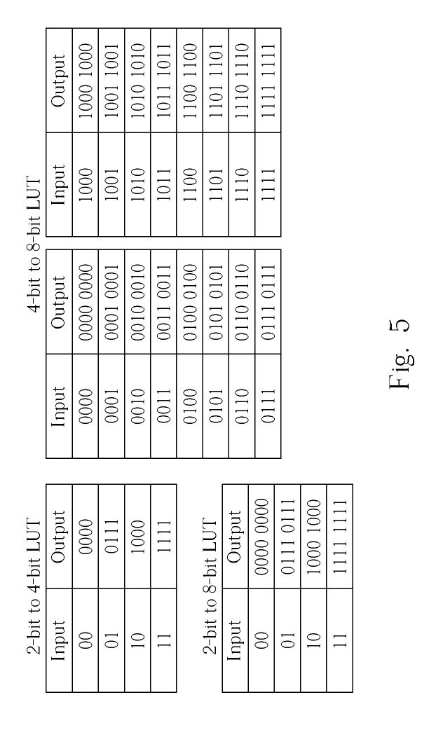

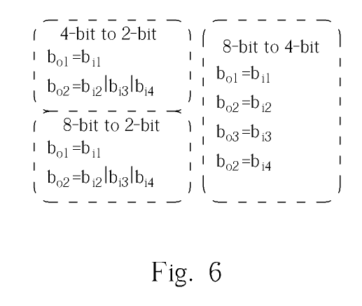

The palette table 220 stores a second blending value corresponding to every color and the image data of the ACLUT format contains a first blending value corresponding to every pixel. The GDM 118 selects the first or the second blending value according to the blending selection bit 314 to process at least one pixel according to the selected blending value and generates target image data. The target image data is stored in the memory 110. In some cases, the first blending value is more suitable for the image data; however, in other cases, the second blending value is more suitable for the image data. By selecting the above-mentioned blending values, the present invention ensures designers use the image data of the digital TV 100 effectively. This embodiment further comprises an input interface for designers to input the value of the blending selection bit 314. FIG. 5 is a reference table of different look-up table (LUT) format conversions performed by the graphic drawing module 118 according to the present invention, and FIG. 6 is a diagram illustrating the conversion rules used by the graphic drawing module 118 according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for processing source image data, the apparatus comprising:
a memory for storing the source image data having a first format, the source image data comprising a first blending value and first data;
a storage unit for storing a blending selection value; and
a graphic drawing module, coupled to the memory and to the storage unit, for producing a second blending value according to the first data, selecting the first blending value or the second blending value according to the blending selection value, converting the source image data into target image data according to the selected blending value and the first data.

2. The apparatus of claim 1, wherein the graphic drawing module comprises:
a palette table adapted to produce a second blending value according to the first data.

3. The apparatus of claim 2, wherein the graphic drawing module further comprises:
a color gradient unit adapted to perform a gradient operation according to a gradient parameter such that the target image data has a gradient effect.

4. The apparatus of claim 1, wherein the first format is an ACLUT (alpha color look-up table) format.

5. The apparatus of claim 1, further comprising:
an input interface for inputting the blending selection value into the storage unit.

6. The apparatus of claim 1, wherein the graphic drawing module comprises:
a color gradient unit adapted to perform a gradient operation according to a gradient parameter such that the target image data has a gradient effect.

7. The apparatus of claim 6, wherein the gradient parameter is stored in the storage unit.

8. An apparatus for processing source image data, the apparatus comprising:
a storage unit for storing at least one gradient parameter;
a graphic drawing module coupled to the storage unit for receiving the source image data to perform a gradient operation, and outputting a target image data having a gradient effect, wherein the gradient parameter corresponds to the gradient effect; and
a memory coupled to the graphic drawing module for storing the target image data.

9. The apparatus of claim 8, wherein the graphic drawing module comprises:
a color gradient unit adapted to perform the gradient operation according to the gradient parameter to produce the target image data.

10. The apparatus of claim 9, wherein the storage unit further stores a saturation parameter, and the color gradient unit determines whether or not to limit a range of pixel values in a specific interval according to the saturation parameter.

11. The apparatus of claim 10, wherein the storage unit further stores a blending selection value; wherein the graphic drawing module produces a selected blending value according to the blending selection value, and processes the source image data according to the selected blending value to produce the target image data.

12. The apparatus of claim 8, wherein each gradient parameter comprises a first axis gradient parameter and a second axis gradient parameter.

13. The apparatus of claim 8, wherein the storage unit further stores a blending selection value; wherein the graphic drawing module produces a selected blending value according to the blending selection value, and processes the source image data according to the selected blending value to produce the target image data.

14. A method for processing source image data, the method comprising:
receiving the source image data from a memory, the source image data comprising a first blending value and first data;
receiving a blending selection value from a storage unit;
producing a second blending value according to the first data;
selecting the first blending value or the second blending value according to the blending selection value; and
converting the source image data into target image data according to the selected blending value.

15. The method of claim 14, wherein the source image data complies with an ACLUT (alpha color look-up table) format.

16. The method of claim 14, further comprising:
performing a gradient operation according to a gradient parameter such that the target image data has a gradient effect.

17. The method of claim 16, wherein each gradient parameter comprises a first axis gradient parameter and a second axis gradient parameter.
